(19) United States
(12) Patent Application Publication
(10) Pub. No.: US 2026/0203841 A1
(43) Pub. Date: Jul. 16, 2026

(54) SYSTEMS AND METHODS FOR SELECTING, COMPARING, AND MANAGING PROPERTY-RELATED SERVICE PROVIDERS

(71) Applicants: Taylor Smuk, Naples, FL (US); Sean Smuk, Naples, FL (US)

(72) Inventors: Taylor Smuk, Naples, FL (US); Sean Smuk, Naples, FL (US)

(21) Appl. No.: 19/447,141

(22) Filed: Jan. 13, 2026

Related U.S. Application Data
(60) Provisional application No. 63/744,965, filed on Jan. 14, 2025.

(51) Int. Cl. G06Q 50/16

(52) U.S. Cl. CPC G06Q 50/16

(57) ABSTRACT

A computer-implemented platform for selecting, ranking, and comparing property-related service providers is disclosed. One or more servers store provider profiles populated from roster feeds and platform inputs, including pricing models, declared services, specializations, geographic coverage, and performance metrics. The servers generate user interfaces that receive user-defined selection criteria and compute, for each candidate, a relevance score using configured weights and hard filters applied to schema-bound attributes. The platform orders candidates by score and returns paginated identifiers with presentation fields, and further generates side-by-side comparison outputs that align normalized fields across selected providers. The system also initiates direct electronic communication and scheduling between a user and a selected provider, persisting messages and meeting objects and issuing notifications, thereby delivering criteria-driven discovery, machine-generated comparison views, and integrated engagement on conventional computing infrastructure.

### CROSS-REFERENCE TO RELATED APPLICATIONS

The present application claims priority to U.S. Provisional Application No. 63/744,965 filed Jan. 14, 2025, titled “REAL ESTATE AGENT SELECTION AND MATCHING PLATFORM WITH TRANSPARENT FEES AND SERVICES,” which is hereby incorporated by reference in its entirety.

### TECHNICAL FIELD

The embodiments generally relate to the technical field of systems and methods for computer-implemented selection, comparison, filtering, and matching of property-related service providers.

### BACKGROUND

Conventional platforms for connecting real estate professionals with clients operate through networked directories, listings portals, and brokerage websites. These systems typically maintain agent profiles that include contact details, licensing information, geographic service areas, and marketing descriptions. Many platforms aggregate multiple listing service data and public records to present market activity around a property search, while separately providing agent rosters sourced from associations or brokerage databases. Users interact through web or mobile interfaces to browse profiles, submit inquiry forms, or request callbacks from selected professionals.

Lead generation services commonly route consumer inquiries to participating agents using geographic rules, rotating queues, or paid placement. These services receive user contact information and high level preferences, create a lead object in a database, and assign the lead to an agent account for follow up. Some platforms enable paid tiers that increase profile visibility, highlight featured listings, or provide additional communication tools. Agent teams and brokerages often supplement these services with customer relationship management software that tracks outreach, logs messages, and schedules appointments.

Ratings and review sites collect user feedback and publish aggregated scores alongside qualitative comments. These systems usually verify participants through email or account credentials and apply moderation workflows to screen content. Search engines and general marketplaces index agent pages and allow users to filter by location, language, or brokerage affiliation. Messaging features on these platforms range from simple web forms that forward emails to embedded chat modules that relay messages through platform servers before notifying the agent by email or push notification.

Conventional systems provide broad discovery but rely on user driven filtering of profiles and services. Profile data tends to originate from self reported fields, brokerage provided rosters, and public association records that update on periodic schedules. Many ranking approaches emphasize sponsored placement, basic proximity, or aggregated review scores. Scheduling often proceeds through separate calendaring tools, and communications can span email, phone, and in platform messaging without a unified history. These arrangements serve typical search and contact needs while leaving users to compare fee structures, service offerings, and historical activity using information gathered across multiple sources.

Enterprise tools within brokerages manage agent onboarding, compliance, and marketing collateral. These systems integrate with association data to confirm licensing status and synchronize roster changes to public facing websites. Internal forums and referral networks allow professionals to share opportunities and coordinate events. Access controls, authentication, and role based permissions govern who can view internal materials, and content typically appears in chronological feeds or threaded discussions.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

The disclosed system operates on one or more application servers with processors, memory, and a network interface and stores provider profiles in a database populated from association rosters and platform inputs. Provider profiles may represent multiple categories of property-related service providers, including licensed real estate agents, short-term rental hosts, and other property service professionals. The processors expose network APIs that deliver user interfaces on client devices and accept authenticated updates from providers.

The disclosed system receives user-defined selection criteria and computes results using structured, schema-bound attributes rather than advertising spend or referral bidding. The processors transform fee models, declared services, market or property-type specializations, geography, and historical activity into feature vectors and apply configured weights and hard filters to compute a relevance score for each candidate. The system orders candidates by score and returns paginated identifiers with presentation fields for rendering.

The disclosed system generates comparison outputs in addition to ranked lists. The user interface may render a side-by-side comparison view that aligns selected providers across normalized fields such as pricing model, included services, specialization, coverage area, past activity, reviews, and availability. The servers assemble these comparison views by querying the database for the selected provider identifiers and emitting a structured response that the client displays without manual copy and paste by the user.

The disclosed system consolidates engagement and logistics in the same workflow. The interface exposes authenticated messaging and embedded scheduling so that a user can initiate direct electronic communication and propose meeting times or calls with a selected provider. Messages, meetings, and read states persist in the database, and notifications propagate through integrated channels so that both parties view a unified history tied to the comparison and selection context.

The disclosed system provides transparency and adaptability. Configuration data defines the weights and filters used for scoring, and audit records capture roster updates and provider edits to profile fields. Administrators may tune criteria or add provider categories without altering client code by updating schemas and configuration records. Collectively, these mechanisms deliver multi-category discovery, deterministic scoring, machine-generated comparison views, and integrated communications on conventional computing infrastructure.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments;

FIG. 3 depicts a computer-implemented method executed by cooperating components of application program to select and connect users with property-related service providers, according to some embodiments;

FIG. 4 presents an operational flow executed by application program to deliver ranked agent results and integrated communications, according to some embodiments; and

FIG. 5 illustrates a sequence of machine operations executed by application program across cooperating modules to deliver ranked agent results, premium content, and integrated communications, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

A communication module may manage authenticated sessions between client devices and the server system. The module may terminate TLS, validate tokens, enforce rate limits, and route requests to internal services. The module may expose endpoints for bootstrap, search, comparison, profile update, messaging, scheduling, media retrieval, and forum operations. A persistent channel such as a websocket may deliver server events to clients so that updated rankings, new messages, or meeting status changes appear without polling. The communication module may broker push or email notifications through third party services when a recipient is offline.

A data ingestion module may populate and refresh provider records by integrating roster and catalog feeds from multiple sources. For licensed real estate agents, the module may authenticate to an association roster service, request exports on a schedule, and transform returned fields into normalized schema entries. For short-term rental hosts or other provider classes, the module may import partner or self-registration feeds that supply identity, service coverage, and offering attributes. The module may reconcile duplicates through deterministic matching on identifiers and contact fields, maintain a staging area for validation, and upsert consolidated records into the database. A change log may record the source, time, and type of each update to support audit and rollback.

A profile management module may maintain structured records for providers and users and serve those records to other modules. The provider schema may encode pricing models such as flat fee, hourly, commission, revenue share, or nightly rate with range bounds and currency units. Declared services may include, for example, listing preparation, staging, photography, social media promotion, tenant screening, property maintenance, cleaning, and short-term rental turnover. Specialization flags may identify residential, commercial, and rental segments, and subcategories may capture apartments, marinas, golf courses, seasonal rentals, or furnished corporate housing. Coverage may be represented by polygons, postal codes, or numeric radii, and performance metrics may include closed transactions, occupancy rate, average days to book, review aggregates, and date-stamped activity snapshots. The module may validate agent-only fields, such as licensing status, for records mapped to association rosters while allowing unlicensed provider classes to omit those fields. For users, the schema may store saved criteria, comparison sets, message threads, and meeting preferences.

A scoring and matching engine may compute a relevance score for each provider relative to a user's current criteria. The engine may transform inputs into a weight vector that includes fee model preferences, selected services, budget, specialization, geography, and performance emphasis. The engine may assemble a feature vector for each candidate from the database that includes normalized pricing ranges, a service bitmap, specialization flags, geometric coverage, and performance values. The engine may apply hard filters for required services and specialization, evaluate sub scores for fee alignment, service coverage completeness, geographic proximity or inclusion, and normalized performance on a rolling window, and then produce a score by summing weighted sub scores. Configuration records in storage may specify the weight values so that administrators can adjust behavior without code changes. The engine may return ordered identifiers, scores, and rationale fragments that identify which factors contributed most, enabling transparent results.

A user interface module may generate server responses that render both ranked lists and comparison outputs. On a search page, the client may request an initial page of candidates and render cards that show name, category, pricing model tags, service badges, specialization, coverage area, and performance summaries. Filter controls may capture fee type, budget range, desired services, property type, and geography. When the user adjusts a filter, the client may send a normalized criteria object and request an updated list that the module returns without a full page reload. The same module may generate a comparison view. In this view, the client sends a set of selected provider identifiers and the server returns a normalized table that aligns fields across categories. For example, the response may include a column for each selected provider and rows for pricing model, included services, add-on services, specialization, coverage, recent activity, review aggregates, and availability. The module may compute row order and value normalization so different categories remain comparable, such as mapping agent commission ranges and host nightly rates into a normalized cost per transaction or cost per booking dimension where disclosed.

A scheduling and messaging module may create direct communication channels and appointment objects. When a user selects a provider and initiates contact, the module may create a conversation object keyed to user and provider identifiers and may store messages, read receipts, and attachments. For appointments, the module may collect meeting type, proposed time windows, location or video link preferences, and optional service tasks and may create a meeting object with pending status. The module may update status upon acceptance or counterproposal and notify participants through the communication module. Conversation and meeting records may appear in context next to ranked or compared providers so that users can manage outreach without leaving the workflow.

An access control and premium feature module may govern authentication and authorization and may enable enhanced profile capabilities. The module may enforce role-based permissions for providers, users, and administrators. For licensed agents, the module may verify license identifiers and association membership before unlocking agent-only fields. For premium tiers, the module may allow providers to upload video introductions, add testimonials, and expose advanced availability data. The module may validate media formats, store assets in a media bucket, and associate rendition metadata with profile records. When a client requests a profile or comparison that references premium media, the module may authorize access and hand off to the display pipeline.

A provider forum module may supply an authenticated collaboration space for professionals. The module may restrict access to verified providers and may allow creation of posts, referral requests, and coordination threads for events such as open houses or short-term rental turnovers. Posts may accept attachments and tags. The module may write thread objects to the database and expose activity streams over the communication module so that subscribed clients receive updates in near real time.

The database engine may support transactional storage for providers, users, conversations, meetings, comparison sets, media assets, forum posts, and configuration. Tables or collections may include secondary indexes on service flags, specialization, geography, and pricing ranges to support efficient filtering. A geometry index may evaluate inclusion tests and distance calculations for service areas. A materialized view or cache layer may maintain top results for common criteria and may invalidate on write events from ingestion or profile edits.

In one operational flow, a user opens the client and the communication module authenticates the session. The user interface module requests facet metadata and an initial candidate page. The profile management module reads facet vocabularies and the scoring and matching engine computes scores subject to default weights. The module returns a page of ordered providers, which the client renders as cards. The user selects desired services, sets a budget, narrows geography, and adds a property type. The engine recomputes scores and the client updates the list. The user then adds two providers to a comparison set. The user interface module queries normalized fields for the selected identifiers and returns a structured grid. The client displays a side-by-side comparison that the user can export or save.

As an alternative operational flow, a short-term rental traveler filters by nightly rate range, cleaning service availability, and proximity to a polygon drawn on a map. The scoring and matching engine treats nightly rate alignment as the fee sub score, maps cleaning availability into the service coverage sub score, and computes the geographic sub score from the polygon. The ranked list appears with occupancy and review aggregates in the performance row of each card. The user adds two hosts and one property manager to the comparison view. The module normalizes pricing into cost-per-stay estimates using the stay length supplied by the user so the table aligns cost semantics across different models.

The platform may support transparent scoring. When requested, the scoring and matching engine may return a rationale payload with each candidate that identifies active filters and the top contributing sub scores. The user interface may render tooltips or a detail drawer that explains how the score was computed from fee alignment, service coverage, geography, and performance. Administrators may enable or disable rationale visibility by configuration.

The platform may implement several ranking variants. A deterministic variant may use only user-selected criteria and stored weights. A preference-assisted variant may introduce a learned vector derived from the user's prior selections while constraining the output to respect active hard filters. A locality-aware variant may add a decay function on distance for certain categories. Each variant executes as a machine process over schema-bound features and does not rely on advertising placement or auction bids.

The platform may handle media efficiently. The display module may transcode uploaded videos into multiple resolutions, select an appropriate rendition for the requesting device, and cache thumbnails for comparison rows. Media URLs may expire and require signed requests that the access control and premium feature module grants when the session has permission.

The platform may provide administrative tooling. Administrators may adjust weight configurations, define new provider categories, introduce new service flags, and publish updated facet vocabularies through configuration records. The data ingestion module may add a mapping for a new feed by defining field transforms and validation rules. The user interface module may render new categories in comparison rows automatically because the response aligns to schema names.

The system may record audit trails. When a provider edits pricing or services, the profile management module may write a prior value, new value, user identifier, and timestamp to an audit table. When ingestion updates a roster-linked record, the system may record the source and change set. Administrators may review these logs to resolve disputes and to diagnose unexpected ranking changes.

The system may implement privacy and security practices. The communication module may enforce least-privilege scopes on tokens. The database may separate personally identifiable information from public profile fields and may encrypt sensitive columns. Media accesses may require time-limited signatures. The scheduling and messaging module may redact specific fields from notifications when an administrator configures stricter privacy rules for a category.

The platform may interoperate with external calendars and messaging systems. When a meeting is accepted, the scheduling and messaging module may generate a calendar invitation compatible with common providers. If configured, the module may embed a video link from an external meeting service. The communication module may deliver confirmation to both parties and update the meeting object with provider-specific identifiers so future changes remain synchronized.

The architecture may scale horizontally. The communication module may run as a front-end tier, the data ingestion and profile management modules may run as services behind an internal gateway, the scoring and matching engine may run as a stateless service that reads features and returns ordered identifiers, the scheduling and messaging module may use a message queue to fan out notifications, and the provider forum module may run behind the same authentication gateway as provider account pages. These processes may communicate over authenticated internal APIs so that individually scaled services remain isolated and fault tolerant.

Various implementations of the invention involve the technical field of computer-implemented selection, ranking, and matching of property-related service providers and clients via networked computing platform including obtain agent data comprising commission structures, services offered, areas of specialization, and performance metrics; integrate roster data received from a National Association of Realtors data source to populate agent profiles; generate for display a user interface listing a plurality of agents; receive user-defined selection criteria including at least one of fee structure type, selected services, budget, geography, specialization, and historical performance; compute for each agent a relevance score based on the user-defined selection criteria; filter and order the plurality of agents according to the relevance score; and enable direct electronic communication between a user and at least one selected agent without an intermediary and are therefore necessarily rooted in computer technology. For example, the aforementioned steps are inherently computer-based and cannot be performed in the human mind. The present invention amounts to more than merely implementing the generic computer as a tool to gather, analyze, and output data because the steps of the present method, system, or product improve the computer-implemented selection, ranking, and matching of property-related service providers and clients via networked computing platforms by providing a concrete, computer implemented matching solution that integrates association roster feeds with structured agent profiles, transforms user criteria into weighted relevance scores, and delivers ranked results with embedded messaging and scheduling in a single networked platform. Processors ingest and normalize roster data into a defined schema for fee models, declared services, market specializations, geography, and performance metrics, then execute a scoring pipeline that evaluates hard constraints and computes numeric sub scores to order candidates. The user interface renders facet controls that drive incremental queries, and the server returns updated pages without full reloads while maintaining a unified communication and meeting record. These operations replace manual cross site comparisons and ad hoc outreach with specific data structures, defined transformations, and deterministic ranking logic implemented by software modules executing on servers and client devices. The claimed subject matter is not merely organizing human activity on generic computers because it recites particular machine operations that include authenticated data ingestion from external rosters, schema constrained storage, algorithmic scoring tied to configured weights, and integrated real time communication workflows that change how agent data is processed and delivered. The result is a practical application that improves the functioning of a computer based matching system by reducing manual filtering, increasing result relevance through computed scores, and consolidating communication and scheduling within the same technical stack. Additionally, the steps of the present invention would be impossible to accomplish on pen and paper due to the volume of data being communicated and received over a network in real-time. In particular, the speed at which the steps of the present invention occur to effectuate the disclosed method, system, or product would involve large-scale, continuous wireless communication of such data. That is, the steps of the present method, system, or product are impossible to accomplish on pen and paper, cannot be accomplished as a method of organizing human activity, and amount to significantly more than merely gathering, analyzing, and outputting data.

Implementations of the present invention include implementing (executing, running, or deploying) one or more artificial intelligence models on a computing device wherein the computing device executes the artificial intelligence model's algorithms and mathematical functions on computer hardware using machine learning libraries. The computing device implements the artificial intelligence model when it performs tasks like training, making predictions, applying the model to data, decision-making, classification, or generating outputs based on inputs. In particular, the speed at which an artificial intelligence model analyzes and transforms data to effectuate the disclosed method, system, or product would involve large-scale, continuous transformation of such data. As such, the present invention would be impossible to accomplish on pen and paper or in the human mind due to the volume of data being analyzed and transformed by the artificial intelligence model.

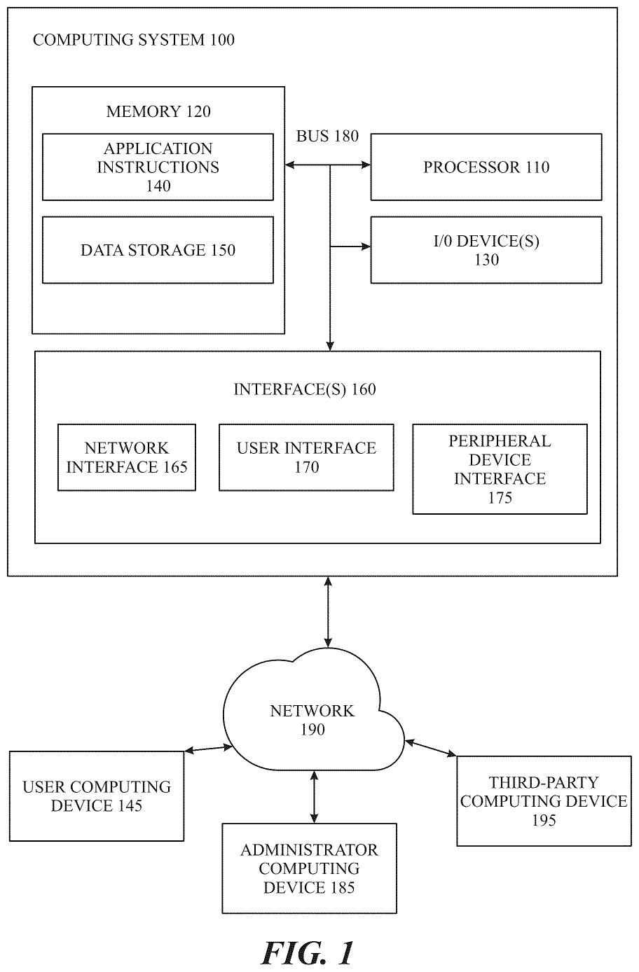

FIG. 1 illustrates an example of a computing system 100 that may provide the execution environment for implementing the processes and methods described herein. The computing system 100 may take various forms depending on deployment context, including but not limited to: a desktop or laptop computer, a tablet or smartphone, a server in a data center, a network appliance, a mainframe computer, a workstation, or a cloud-hosted virtual machine. In some embodiments, the computing system 100 may correspond to a distributed computing environment, such as a cluster of servers executing containerized workloads (e.g., Docker, Kubernetes), or an edge device integrated into Internet of Things (IoT) environments. In other embodiments, the computing system 100 may be embedded in another device, such as a vehicle infotainment unit, a medical diagnostic machine, an industrial robot controller, or a wearable computing device.

The computing system 100 includes one or more processors 110 operably coupled to a memory 120 via a system bus 180. The processor 110 may be implemented as a general-purpose central processing unit (CPU), a graphics processing unit (GPU), a tensor processing unit (TPU), a digital signal processor (DSP), or any combination thereof. In some embodiments, the processor 110 may be an application-specific integrated circuit (ASIC) optimized for a particular workload, a field-programmable gate array (FPGA), or a quantum or neuromorphic processor in advanced implementations. The processor 110 may include single-core, multi-core, or many-core configurations and may support hardware virtualization, multithreading, or parallel execution environments to optimize system performance.

The memory 120 may include volatile memory, nonvolatile memory, or a combination thereof. Volatile memory may include system RAM, cache memory, or high-bandwidth memory (HBM). Nonvolatile memory may include flash storage, solid-state drives (SSD), magnetic hard disk drives (HDD), optical storage devices, or persistent memory technologies such as Intel Optane. The memory 120 stores application instructions 140 for carrying out the functionalities described herein and data storage 150 for maintaining information related to system operations. The application instructions 140 may include code written in languages such as C, C++, Java, Python, Go, Rust, or JavaScript, as well as machine learning models trained using frameworks such as TensorFlow or PyTorch. The data storage 150 may contain structured information such as relational database records, unstructured data such as text or images, or real-time telemetry streams. In cloud-based embodiments, the memory 120 may represent scalable storage resources provisioned on-demand through Infrastructure-as-a-Service (IaaS) providers.

The computing system 100 may also include one or more input/output (I/O) devices 130. These devices may encompass visual output devices such as monitors, head-mounted displays, augmented reality (AR) glasses, or projectors; input devices such as keyboards, mice, touchscreens, styluses, or game controllers; and sensor devices such as microphones, cameras, depth sensors, biometric scanners, or environmental sensors. In industrial or medical environments, the I/O devices 130 may include robotic actuators, infusion pumps, or diagnostic imaging scanners. In vehicular environments, the I/O devices 130 may include in-cabin displays, steering sensors, and connected infotainment systems.

The computing system 100 further comprises one or more interfaces 160 that enable communication with other systems, users, or peripheral components. The network interface 165 allows the computing system 100 to exchange data with external systems across a network 190 using wired or wireless protocols. Example communication standards include Ethernet, Wi-Fi, Bluetooth, 5G, Long-Term Evolution (LTE), satellite communication, or emerging protocols such as Wi-Fi 7 or ultra-wideband (UWB). In some embodiments, the network interface 165 supports secure protocols such as HTTPS, TLS, or VPN tunneling to ensure authenticated and encrypted data transfer. The user interface 170 may include APIs, graphical user interfaces (GUIs), command-line interfaces (CLIs), or natural language interfaces enabled through speech recognition or chatbot systems. The peripheral device interface 175 enables connectivity with external hardware such as printers, external storage arrays, or specialized scientific equipment.

The network 190 represents any communication infrastructure capable of facilitating data exchange between computing entities. In some embodiments, the network 190 corresponds to a local area network (LAN) within a home or enterprise environment. In other embodiments, the network 190 may be a wide area network (WAN), a metropolitan area network (MAN), a peer-to-peer (P2P) communication mesh, or the global Internet. The network 190 may employ cloud orchestration layers, software-defined networking (SDN), or edge computing gateways. In high-security applications, the network 190 may implement firewalls, intrusion detection systems, or zero-trust architectures to protect transmitted data.

The computing system 100 is illustrated as being in communication with multiple external devices, including a user computing device 145, an administrator computing device 185, and a third-party computing device 195. The user computing device 145 may be a smartphone, tablet, laptop, or smart appliance configured to execute client-side applications or interact with system services. The administrator computing device 185 may be a workstation or remote management console configured to perform oversight functions such as monitoring, auditing, updating, or troubleshooting. The third-party computing device 195 may represent a partner system, vendor service, or external application interface that exchanges data with the computing system 100 via secure APIs. In cloud or SaaS embodiments, these devices may also include external microservices, data warehouses, or federated learning nodes.

In some embodiments, the computing system 100 may be deployed in a client-server model, where the computing system 100 acts as a backend server managing requests from client devices. In other embodiments, the computing system 100 may function within a cloud-native environment, operating as a microservice within a container orchestration platform. In edge deployments, the computing system 100 may be optimized for low-latency local processing, while synchronizing with centralized cloud infrastructure for data persistence and global coordination.

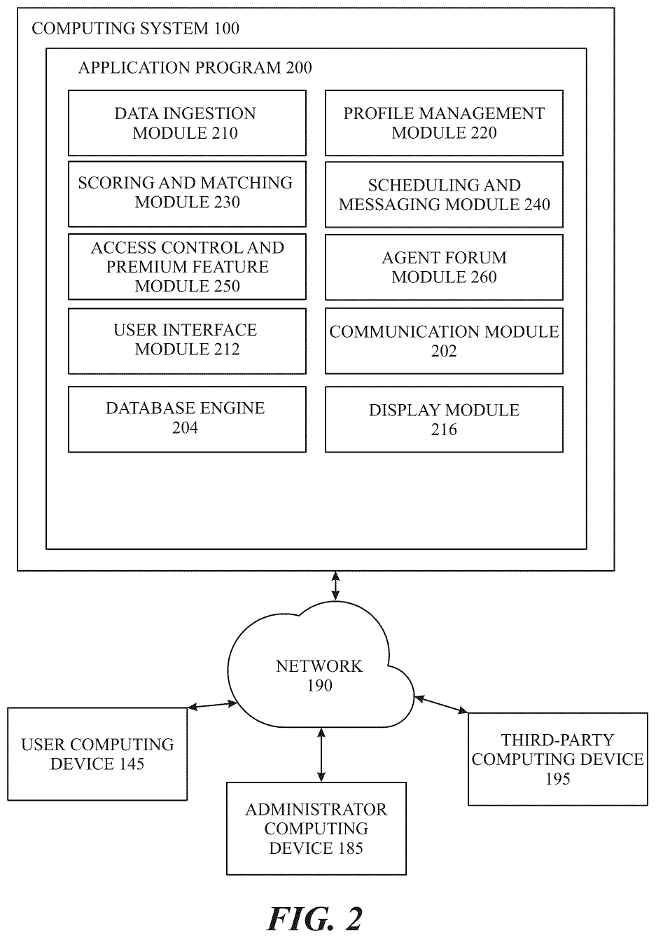

FIG. 2 illustrates a computing system 100 that executes an application program 200 composed of cooperating modules that implement agent selection, ranking, and collaboration features over a network 190. The computing system 100 may include one or more processors coupled to memory and persistent storage and may communicate with a user computing device 145, an administrator computing device 185, and a third party computing device 195 through the network 190. The user computing device 145 may run a browser or mobile client that issues API requests and renders interactive views. The administrator computing device 185 may provide controls for ingest schedules, configuration, and moderation. The third party computing device 195 may host external data sources or notification services that exchange messages with the application program 200. Within the computing system 100, the application program 200 exposes service endpoints and real time channels and coordinates data access through a database engine 204 while producing client facing views through a display module 216.

A communication module 202 manages connectivity between external devices and the application program 200. The communication module 202 may terminate TLS sessions, authenticate requests using tokens or session cookies, and apply rate limiting and request validation. The module 202 may expose REST or gRPC endpoints for query and update operations and may provide a websocket or similar channel to deliver near real time events to the user computing device 145. When a client posts a message or a meeting proposal, the communication module 202 receives the payload, verifies sender identity, stamps timing metadata, and forwards the request to the appropriate downstream module. The module 202 may also integrate with third party notification providers on the third party computing device 195 to dispatch email or push alerts that mirror in platform events.

A data ingestion module 210 acquires external roster and profile inputs and normalizes them to the application schema. The data ingestion module 210 may authenticate to association operated endpoints, schedule periodic downloads, and apply field mapping rules that transform provider records into stored entities. The module 210 may parse identifiers, licensing status, office affiliations, and service areas and may reconcile conflicts by consulting staging tables in the database engine 204 before promoting updates to live profiles. The module 210 may expose administrative controls on the administrator computing device 185 to adjust polling intervals, review change logs, and approve exceptions. On completion, the module 210 writes normalized agent records and update history into the database engine 204 to support later filtering and ranking.

A profile management module 220 maintains structured records for agents and users and serves these records to other modules. The profile management module 220 may define schemas for fee models that include flat fee, hourly, and commission based types with numeric ranges, as well as declared services such as print marketing, social media advertising, staging, and open house coordination. The module 220 may also persist market specialization flags for residential, commercial, and rental segments, along with performance metrics such as sales counts, sales volume, close dates, and review aggregates. The module 220 may validate edits from authenticated agents, enforce field constraints, manage media attachments for premium profiles, and expose indexed queries to the scoring and matching module 230 and the user interface module 212 through the database engine 204.

A scoring and matching module 230 computes relevance scores that drive ranked agent results. The scoring and matching module 230 may receive selection criteria from the user interface module 212 that include fee structure preferences, selected services, budget, geography, specialization, and performance weighting. The module 230 may transform the criteria into a weight vector and compute for each candidate agent a set of sub scores that measure service coverage, fee alignment, specialization match, geographic proximity or service area inclusion, and normalized performance metrics. The module 230 may apply hard filters for criteria that must be satisfied, sum weighted sub scores to produce a relevance score, and return ordered identifiers to the user interface module 212 for display. Configuration values that control weights and filters may be stored in the database engine 204 to allow administrative tuning without code changes.

A scheduling and messaging module 240 provides direct communication and appointment creation between users and agents. The scheduling and messaging module 240 may create conversations, persist messages with delivery status, and broadcast updates through the communication module 202 to active clients. For appointments, the module 240 may receive a meeting request containing time windows and location or video link preferences, create a meeting object with pending status, and track responses from the agent. On acceptance, the module 240 may generate calendar entries and send notifications via the communication module 202 and, if configured, via services on the third party computing device 195. Conversation and meeting entities may be stored in the database engine 204 to maintain a unified history accessible from both participant accounts.

An access control and premium feature module 250 governs authentication, authorization, and enhanced profile capabilities. The access control and premium feature module 250 may enforce role based permissions so that licensed agents manage agent facing settings and consumers manage personal preferences. The module 250 may evaluate account tier flags to permit upload of video introductions and entry of client testimonials and may validate and store associated media assets. When the scoring and matching module 230 produces ranked results, the module 250 may supply premium profile attributes to the user interface module 212 so that the client can render richer content where relevant to the current criteria. Administrative roles may be verified through the module 250 before granting access to ingestion dashboards or moderation tools.

An agent forum module 260 delivers an authenticated collaboration space for licensed professionals. The agent forum module 260 may verify agent credentials through stored association identifiers before granting access. Within the forum, the module 260 may create and index topics, accept posts with attachments, and maintain threads that capture off market listings, open house coordination, and referral opportunities. The module 260 may implement moderation actions such as edit, archive, and report and may expose search and tagging features. Posts, comments, and attachment metadata may be persisted through the database engine 204 and surfaced to clients through the communication module 202 for timely updates.

A user interface module 212 generates client facing responses that render search facets, ranked agent cards, profile pages, and collaboration views. The user interface module 212 may assemble JSON payloads that include facet metadata, paginated result sets, and presentation flags and may coordinate incremental updates when a user adjusts filters. The module 212 may also prepare conversation threads and scheduling dialogs and may request additional assets when a profile indicates premium media. To support server side rendering or asset packaging, the module 212 cooperates with the display module 216.

The database engine 204 provides transactional storage and indexed retrieval for all persistent entities used by the application program 200. The database engine 204 may define tables or collections for agents, services, fees, markets, performance metrics, users, messages, meetings, forum posts, media assets, and configuration. The engine 204 may maintain secondary indexes on service flags, market flags, geography, and fee ranges to accelerate query execution for the scoring and matching module 230 and the user interface module 212. The engine 204 may support ACID transactions for profile updates and message writes and may expose change streams that allow downstream modules to react to updates in near real time.

A display module 216 prepares visual resources and presentation templates used by client applications. The display module 216 may generate server side rendered views in response to initial page loads, compile and serve static assets that include stylesheets and script bundles, and optimize media delivery by transcoding uploaded videos and images into multiple resolutions. The display module 216 may also instrument views with analytics events that inform administrative tuning of weight configurations and interface layout. While much of the rendering occurs on the user computing device 145, the display module 216 coordinates asset delivery and template composition to ensure consistent presentation across devices.

During typical operation, the user computing device 145 connects over the network 190 through the communication module 202 and requests initial facet metadata and a first page of agents. The user interface module 212 queries the profile management module 220 via the database engine 204, hands criteria to the scoring and matching module 230, and returns ranked results with presentation fields assembled by the display module 216. If the user starts a conversation or proposes a meeting, the scheduling and messaging module 240 persists the objects and signals both participants. If an agent updates a profile or uploads premium media, the access control and premium feature module 250 validates the action and the profile management module 220 commits changes in the database engine 204. When association rosters publish updates, the data ingestion module 210 fetches and normalizes records and reconciles them into existing profiles. Licensed professionals who authenticate to the agent forum module 260 may create posts that the communication module 202 disseminates to subscribed clients. The network 190 thereby links external devices with the computing system 100 so that the application program 200 executes coordinated, machine implemented workflows that store, process, rank, and present agent information and support direct collaboration.

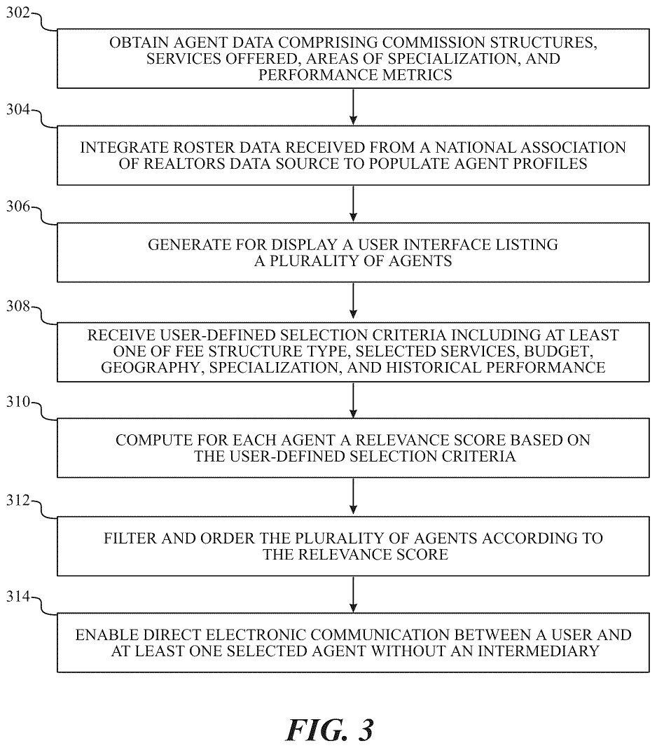

FIG. 3 depicts a computer-implemented method executed by cooperating components of application program 200 to select and connect users with property-related service providers. At step 302, the data ingestion module 210 and the profile management module 220 obtain agent data that include commission structures, services offered, areas of specialization, and performance metrics. The data ingestion module 210 may authenticate to association and brokerage endpoints, pull roster or profile payloads on a schedule, and transform provider fields into normalized entries. The profile management module 220 may persist the normalized entries in database engine 204 using schemas that encode fee model type with numeric ranges, declared service flags, specialization categories for residential, commercial, and rental segments, and performance fields such as sales counts and review aggregates. These modules cooperate so that processors write consistent, queryable agent records with timestamps and provenance.

At step 304, the data ingestion module 210 integrates roster data received from a National Association of Realtors data source to populate agent profiles. The module 210 may parse association identifiers, licensing status, office affiliations, and service area descriptors and may reconcile conflicts with existing records through staging tables in database engine 204. A reconciliation subroutine may perform deduplication, foreign key checks, and change detection. When a change passes validation, the module 210 upserts the agent profile and emits a change event that the profile management module 220 records for audit and that other modules can consume to refresh cached results.

At step 306, the user interface module 212 generates for display a user interface listing a plurality of agents. The module 212 may request a page of candidates from the scoring and matching module 230 and compose a response that includes agent identifiers, presentation fields such as fee tags and service badges, and pagination metadata. The display module 216 may prepare templates and asset references so that a client on user computing device 145 renders a results view. During this step, the communication module 202 maintains an authenticated session, enforces rate limits, and routes requests and responses between the client and the modules that assemble the listing.

At step 308, the communication module 202 receives user-defined selection criteria from the client and forwards them to the user interface module 212. The criteria include at least one of fee structure type, selected services, budget, geography, specialization, and historical performance preferences. The user interface module 212 validates types and ranges, converts geography into a service area or distance constraint, and passes a normalized criteria object to the scoring and matching module 230. The profile management module 220 may provide facet vocabularies and bounds so that inputs align with stored schema values.

At step 310, the scoring and matching module 230 computes for each agent a relevance score based on the user-defined selection criteria. The module 230 may assemble feature vectors from database engine 204 that represent each agent's fee model, service flags, specialization, service area geometry, and performance metrics. The module 230 may apply hard filters for required services or specialization, then evaluate sub scores that measure fee alignment, service coverage, geographic proximity or inclusion, and normalized performance. A weight vector, stored as configuration in database engine 204 and optionally adjustable through administrator computing device 185, scales each sub score. The module 230 sums the weighted sub scores to produce a relevance score S for each candidate and returns ordered identifiers and scores.

At step 312, the user interface module 212 filters and orders the plurality of agents according to the relevance score computed by the scoring and matching module 230. The module 212 may request a paginated slice of ordered identifiers, join presentation fields from profile management module 220, and supply the results to the client through communication module 202. The display module 216 may provide layout templates and media renditions so that the client renders ranked agent cards with consistent formatting. If the user adjusts criteria, the same path repeats to generate an updated list without a full page reload.

At step 314, the scheduling and messaging module 240 enables direct electronic communication between a user and at least one selected agent without an intermediary. When the user initiates contact from a listed agent card, the communication module 202 creates or resumes an authenticated conversation channel. The scheduling and messaging module 240 persists message content, read receipts, and attachments in database engine 204 and may generate meeting objects that include proposed time windows and location or video link preferences. The module 240 notifies the selected agent through push or email integrations and updates conversation state in near real time so that both parties view a unified history within the client. This step completes a machine-executed workflow that begins with authenticated data ingestion and schema-bound storage and proceeds through algorithmic scoring and ranked presentation to a direct, platform-mediated connection.

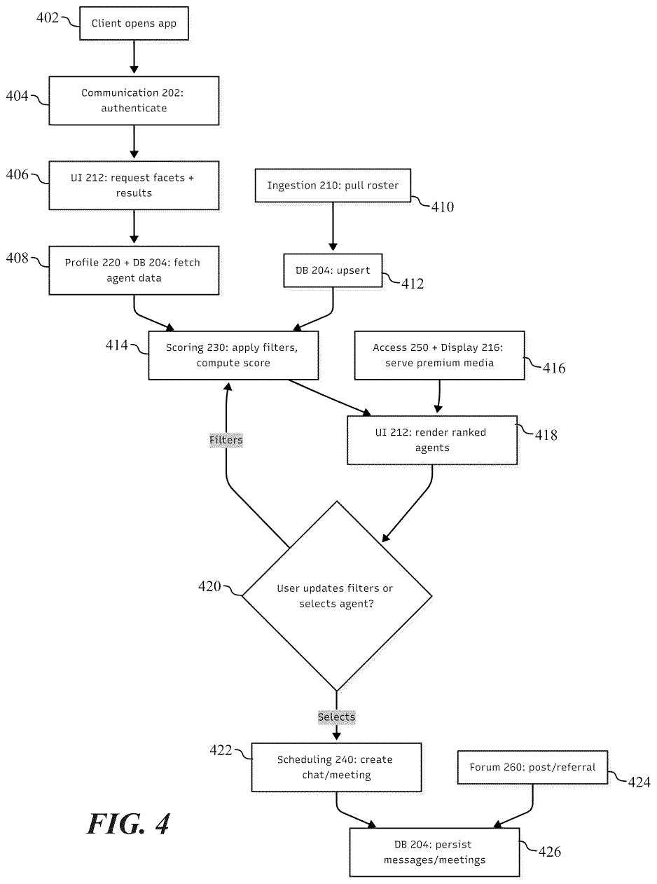

FIG. 4 presents an operational flow executed by application program 200 to deliver ranked agent results and integrated communications. At step 402 a user computing device opens a client that establishes a session with communication module 202. At step 404 communication module 202 authenticates the session using token exchange and session validation, applies rate limits, and routes requests to internal services over secured service endpoints. At step 406 user interface module 212 issues a bootstrap request for facet vocabularies and an initial results page. At step 408 profile management module 220 queries database engine 204 to fetch agent schemas and current profile fields that encode fee model type and range values, declared service flags, market specialization indicators, service area geometries, and performance metrics. In parallel with the interactive path, step 410 shows data ingestion module 210 pulling roster records from an association feed, applying field mapping and conflict resolution, and forwarding normalized entries to database engine 204, which performs upsert operations at step 412 to maintain consistent agent profiles and to emit change events used to refresh ranking inputs.

At step 414 scoring and matching module 230 applies hard filters and computes a relevance score for each candidate. The module 230 forms feature vectors from stored agent attributes and evaluates sub scores for fee alignment, declared service coverage, specialization match, geographic proximity or inclusion, and normalized historical performance. A configuration record stored in database engine 204 provides the weights for each sub score; the module 230 multiplies sub scores by the configured weights and sums the results to obtain a relevance score. The module 230 returns ordered agent identifiers and associated scores to user interface module 212. At step 416 access control and premium feature module 250 authorizes retrieval of premium media when a ranked agent has an eligible account tier, and display module 216 selects or transcodes the appropriate media rendition and provides asset locations for downstream rendering.

At step 418 user interface module 212 renders ranked agents for the client using presentation templates and asset references from display module 216. The client presents filter controls and captures user selections. Decision step 420 branches on user input. When a user updates filters, user interface module 212 sends a normalized criteria payload to scoring and matching module 230, which repeats the filtering and scoring sequence at step 414 to refresh ranks without a full page reload. When a user selects an agent, the flow proceeds to step 422, where scheduling and messaging module 240 creates or resumes a conversation and, if requested, creates a meeting object that includes proposed time windows and location or video link preferences. The module 240 persists messages, meetings, and read receipts in database engine 204 at step 426 and triggers push or email notifications through communication module 202 so that the selected agent receives real time updates.

The flow also depicts a parallel collaboration path at step 424 in which agent forum module 260 processes a post or referral thread from a licensed professional. The module 260 validates agent credentials through access control and premium feature module 250, writes the post, comments, and attachments to database engine 204, and exposes thread updates to subscribed clients through communication module 202. Throughout the sequence database engine 204 supplies transactional storage, secondary indexes on fee, service, specialization, and geography fields for efficient queries, and change streams that allow profile management module 220 and scoring and matching module 230 to invalidate caches and refresh computed ranks when ingestion updates arrive. Collectively, the numbered steps in FIG. 4 show how the disclosed system authenticates users, ingests external roster data, computes deterministic rankings from schema bound features, serves premium media, and enables direct chat and scheduling while persisting a unified history for both participants.

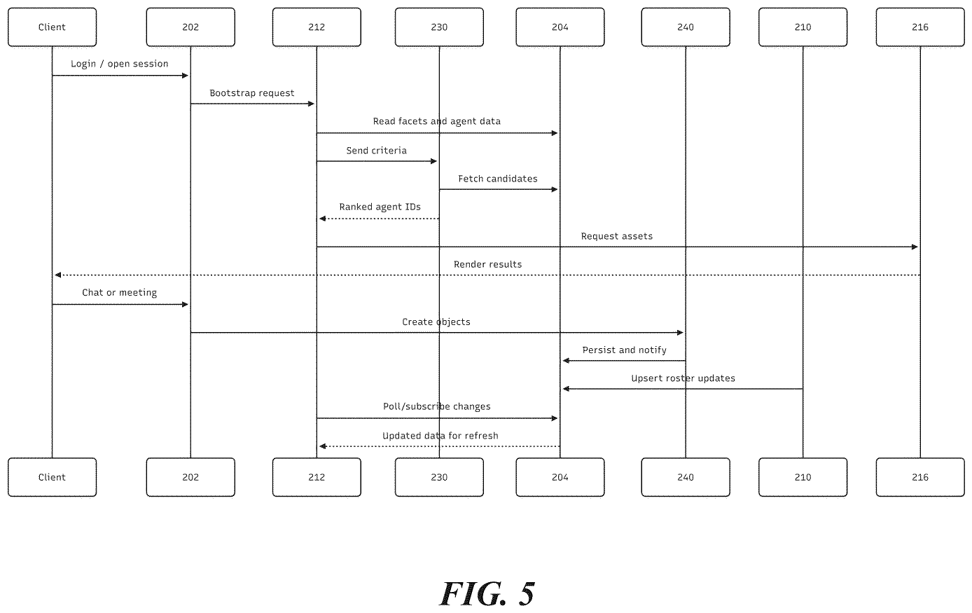

FIG. 5 illustrates a sequence of machine operations executed by application program 200 across cooperating modules to deliver ranked agent results, premium content, and integrated communications. A client at the user computing device initiates the sequence by logging in and opening a session. Communication module 202 authenticates the client, establishes a TLS session, and issues a bootstrap response that includes session tokens and endpoint metadata. User interface module 212 then submits a bootstrap request for facet vocabularies and initial data. Profile management module 220 reads agent schemas, fee model types and ranges, declared service flags, specialization indicators, service area geometries, and performance metrics from database engine 204. Scoring and matching module 230 fetches candidate feature sets and applies configured filters and weight vectors to compute relevance scores, returning ordered agent identifiers to user interface module 212. Display module 216 prepares templates and media references, and the client renders an initial ranked list.

When the user adjusts criteria, user interface module 212 sends a normalized criteria payload to scoring and matching module 230. The module evaluates service coverage, fee alignment, specialization match, geographic proximity or inclusion, and normalized performance, multiplies each sub score by stored weights, and produces a refreshed ordering. User interface module 212 requests assets from display module 216 and transmits an updated results view to the client without a full page reload. If the user selects an agent and initiates chat or a meeting request, communication module 202 forwards the request to scheduling and messaging module 240. The scheduling and messaging module 240 creates or resumes a conversation object, records messages, and creates a meeting object with proposed times and location or video link preferences, then persists both objects within database engine 204 and notifies the agent through push or email integrations.

Data ingestion module 210 operates on a scheduled or event driven basis in parallel with interactive flows. The module authenticates to an association roster source, pulls records, normalizes provider fields to the platform schema, and upserts profiles in database engine 204. The database emits change events that profile management module 220 observes to update derived fields or clear caches. Scoring and matching module 230 subscribes to these change events and invalidates ranking caches for affected geographies or specializations so that subsequent queries incorporate the new roster state. This cross service signaling appears in the sequence as a transition from ingestion to profile management, and from profile management to scoring, followed by updated rankings returned to user interface module 212.

When a ranked agent has premium materials, access control and premium feature module 250 authorizes media access based on the agent's account tier and the viewer's session. Display module 216 selects or transcodes the requested rendition, such as a streaming resolution for video, and returns media locations to user interface module 212 for inclusion in the rendered profile. Throughout the sequence, communication module 202 routes requests and responses, enforces rate limits, and propagates status updates back to the client. Database engine 204 provides transactional storage for messages, meetings, profiles, media metadata, ranking configuration values, and audit logs, and exposes secondary indexes and change streams used by the modules to satisfy the real time updates shown in the figure.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A system for selecting and matching property-related service providers, the system comprising at least one user computing device in operable communication with a user network and an application server in operable communication with the user network, the application server hosting an application program executed by one or more processors coupled to a memory, the one or more processors configured to store provider data in a database and to:
obtain provider data comprising pricing models, services offered, and specializations, and optionally performance-related attributes;
integrate roster data received from one or more association, licensing authority, registry, marketplace, or third-party data sources to populate provider profiles;
generate for display a user interface listing a plurality of providers;
receive user-defined selection criteria including at least one of fee structure type, selected services, budget, geography, specialization, and historical performance;
compute for each provider a relevance score based on the user-defined selection criteria;
filter and order the plurality of providers according to the relevance score;
generating a machine-readable response that renders a side-by-side comparison view for a user-selected subset of providers by aligning normalized fields across the subset; and
enable direct electronic communication between a user and at least one selected provider without an intermediary.

2. The system of claim 1, wherein the application program provides a transaction workspace linked to a user-selected provider and the one or more processors manage transaction-related activities by storing electronic documents, assigning tasks with due dates, tracking task completion states, and recording payment or electronic-signature events associated with the workspace.

3. The system of claim 1, wherein the services offered include at least one of print marketing, social media advertising, staging, and open house coordination, and the user interface presents service checkboxes that constrain the filtering of the plurality of providers to those declaring the selected services.

4. The system of claim 1, wherein computing the relevance score further comprises executing a machine-learned model that generates a preference vector from historical platform interactions and combining the preference vector with user-selected hard filters to adjust feature weights, the processors storing a rationale record that identifies contributing features for the generated score.

5. The system of claim 1, wherein the performance metrics include at least one of past sales and reviews and the relevance score weights the performance metrics relative to the user-defined selection criteria.

6. The system of claim 1, wherein the application program further provides authenticated premium accounts for providers and stores, in association with a premium provider profile, at least one of a video introduction, client testimonials, and identifiers of specialized services.

7. The system of claim 1, wherein the application program exposes a scheduling interface that creates a meeting request between the user and the selected provider through the direct electronic communication.

8. The system of claim 1, wherein the application program generates an provider-only forum accessible to authenticated providers to post off-market listings, coordinate events, and exchange referrals.

9. A computer-implemented method for selecting and matching property-related service providers, the method comprising executing, by one or more processors in operable communication with a user computing device and a database, operations that include:
receiving, from the database and one or more association, licensing authority, registry, marketplace, or third-party data sources, provider data comprising pricing models, services offered, and specializations, and optionally performance-related attributes;
generating and displaying, on the user computing device, a listing of providers;
receiving, from the user computing device, user-defined selection criteria including at least one of fee structure type, selected services, budget, geography, specialization, and historical performance;
computing a relevance score for each provider based on the user-defined selection criteria;
filtering and ordering the listing of providers based on the relevance score; and
establishing direct electronic communication between the user computing device and a selected provider.

10. The method of claim 9, further comprising presenting fee structure facets corresponding to at least flat fee pricing, hourly pricing, and commission-based pricing and restricting the listing of providers based on a selected facet.

11. The method of claim 9, further comprising presenting service facets corresponding to at least print marketing, social media advertising, staging, and open house coordination and restricting the listing of providers to those declaring all services selected by the user.

12. The method of claim 9, further comprising applying a market facet selected from residential, commercial, and rental and filtering the listing of providers to those whose specialization matches the market facet.

13. The method of claim 9, wherein computing the relevance score comprises weighting past sales and reviews relative to at least one of fee structure type and services selected by the user.

14. The method of claim 9, further comprising authenticating an provider to a premium account and displaying, with the provider's profile, at least one of a video introduction, client testimonials, and a specialized service indicator.

15. The method of claim 9, further comprising presenting a scheduling interface that, upon user selection, transmits a meeting request to the selected provider through the direct electronic communication.

16. A non-transitory computer-readable medium storing instructions that, when executed by one or more processors of an application server in operable communication with a user network, cause the one or more processors to perform operations comprising:
storing, in a database, provider data comprising pricing models, services offered, and specializations, and optionally performance-related attributes;
integrating roster data received from one or more association, licensing authority, registry, marketplace, or third-party data sources to populate provider profiles;
generating a user interface that displays a listing of providers and receives user-defined selection criteria including at least one of fee structure type, selected services, budget, geography, specialization, and historical performance;
computing a relevance score for each provider based on the user-defined selection criteria;
filtering and ordering the listing of providers according to the relevance score;
generating a machine-readable response that renders a side-by-side comparison view for a user-selected subset of providers by aligning normalized fields across the subset; and
initiating direct electronic communication between a user device and a selected provider via an in-platform messaging or scheduling interface.

17. The non-transitory computer-readable medium of claim 16, wherein the instructions cause presentation of fee structure controls selectable from flat fee pricing, hourly pricing, and commission-based pricing to constrain the filtering of the listing of providers.

18. The non-transitory computer-readable medium of claim 16, wherein the instructions cause presentation of service selection controls corresponding to at least print marketing, social media advertising, staging, and open house coordination and, in response to user selection, restrict the listing of providers to those declaring the selected services.

19. The non-transitory computer-readable medium of claim 16, wherein the instructions further cause display of premium provider profiles that include at least one of a video introduction, client testimonials, and specialized services and cause the one or more processors to prioritize premium provider profiles meeting the user-defined selection criteria.

20. The non-transitory computer-readable medium of claim 16, wherein the instructions further cause the application server to host an provider-only forum restricted to authenticated providers to exchange off-market listings, coordinate open house events, and transmit referrals.
